(19) United States
(12) Patent Application Publication
(10) Pub. No.: US 2007/0155949 A1
(43) Pub. Date: Jul. 5, 2007

(54) Thermally stable composite material

(75) Inventors: Mark W. Beltz, Attleboro, MA (US); Gwo Swei, Vandalia, OH (US); Pawel Czubarow, Wellesley, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/323,979

(22) Filed: Dec. 30, 2005

(51) Int. Cl. C08G 69/08

(52) U.S. Cl. 528/310

(57) ABSTRACT

A composite material includes polyimide and an additive. The composite material has a glass transition temperature at least about 5% greater than the glass transition temperature of the polyimide absent the additive, the composite material has a thermal oxidative performance at least about 5% relative to the polyimide absent the additive, the thermal oxidative performance based on exposure to air at a temperature of 371° C. and at atmospheric pressure for a period of 120 hours.

### FIELD OF THE DISCLOSURE

This disclosure, in general, relates to thermally stable composite materials, articles formed thereof and methods for making such composite materials and articles.

### BACKGROUND

In industries such as aerospace, automobile manufacturing, and semiconductor manufacturing, increasingly intricate components and tools are used in high temperature environments. Traditionally, manufacturers have used metal and ceramic materials to form such components and tools based on the tolerance of such materials with high temperatures.

Increasingly, polymeric materials are being used as alternatives to metal and ceramic materials. In general, polymeric materials are less expensive, lighter in weight, and easier to form than metal and ceramic materials. Typically, polymer materials are significantly lighter than metal. In addition, polymers often cost less than 1/10 the cost of ceramic materials, can be molded at lower temperatures than ceramics, and are easier to machine than ceramic materials.

However, unlike metal and ceramic materials, polymeric materials tend to degrade at high temperatures. Typically, at elevated temperatures polymeric materials lose mechanical strength. In addition, when exposed to elevated temperatures in an atmosphere including oxygen, polymeric materials tend to lose mass through oxidation and off-gassing. Such a loss of mass often results in changes in the dimensions of an article formed of such polymeric materials. In addition, such a loss of mass typically results in reduced mechanical strength, such as a decrease in tensile strength and elongation properties.

As such, an improved polymeric material would be desirable.

### SUMMARY

In a particular embodiment, a composite material includes polyimide and an additive. The composite material has a glass transition temperature at least about 5% greater than the glass transition temperature of the polyimide absent the additive, the composite material has a thermal oxidative performance at least about 5% relative to the polyimide absent the additive, the thermal oxidative performance based on exposure to air at a temperature of 371° C. and at atmospheric pressure for a period of 120 hours.

In another exemplary embodiment, a composite material includes polyimide and an additive. The composite material has a glass transition temperature of at least about 5.0% greater than the glass transition temperature of the polyimide absent the additive, the composite material has a Degradation Onset Temperature of at least about 550° C.

In a further exemplary embodiment, a composite material includes polyimide formed of the imidized product of pyromellitic dianhydride (PMDA), oxydianiline (ODA), and a terminating agent. The composite material has a thermal oxidative stability weight loss not greater than about 3.0% when exposed to air at a temperature of 371° C. and atmospheric pressure for a period of 120 hours. The composite material has a glass transition temperature at least about 400° C.

In an additional embodiment, a method of forming a composite material includes adding a first precursor of polyamic acid to a mixture, adding a metal oxide particulate to the mixture, adding a second precursor of polyamic acid to the mixture, adding a terminating agent to the mixture. The first precursor, the second precursor, and the terminating agent form polyamic acid. The method also includes imidizing the polyamic acid to form a polyimide matrix including the metal oxide particulate therein.

In another exemplary embodiment, a composite material includes a polyimide and an additive. The composite material has a tensile strength at least about 72.3 MPa (10500 psi) and has a thermal oxidative performance at least about 5% relative to the polyimide absent the additive, the thermal oxidative performance based on exposure to air at a temperature of 371° C. and at atmospheric pressure for a period of 120 hours.

### DETAILED DESCRIPTION

In a particular embodiment, a composite material includes a polyimide matrix and an additive. The additive may include a terminating agent forming end groups on the polyimide, may include a metal oxide particulate dispersed or dissolved in the polyimide matrix, or may include a combination thereof. In an exemplary embodiment, the composite material may include about 0.1 wt % to about 50.0 wt % metal oxide. In another example, the polyimide matrix is the imidized product of a dianhydride, a diamine, and the terminating agent. In an exemplary embodiment, the composite material exhibits improved temperature stability, such as having a thermal oxidative performance of at least about 5% or a thermal oxidative stability weight loss not greater than about 3.0%. The composite material may also have a glass transition temperature at least about 5% higher than the polyimide without additives or at least about 400° C. In addition, the composite material may exhibit a Degradation Onset Temperature at least about 550° C.

In an exemplary method, the composite material may be formed by preparing a mixture including a polyamic acid precursor and a metal oxide particulate. The metal oxide particulate may be milled prior to preparing the mixture. The polyamic acid precursor may react, such as with a second polyamic acid precursor and a terminating agent, to form polyamic acid. The method further includes imidizing or dehydrating the polyamic acid to form a polyimide matrix including the metal oxide.

The polyamic acid precursor includes a chemical species that may react with itself or another species to form polyamic acid, which may be dehydrated to form polyimide. In particular, the polyamic acid precursor may be one of a dianhydride or a diamine. Dianhydride and diamine may react to form polyamic acid, which may be imidized to form polyimide.

In an exemplary embodiment, the polyamic acid precursor includes dianhydride, and, in particular, aromatic dianhydride. An exemplary dianhydride includes pyromellitic dianhydride, 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride or a mixture thereof. In a particular example, the dianhydride is pyromellitic dianhydride (PMDA). In another example, the dianhydride is benzophenonetetracarboxylic acid dianhydride (BTDA) or diphenyltetracarboxylic acid dianhydride (BPDA).

In another exemplary embodiment, the polyamic acid precursor includes diamine. An exemplary diamine includes oxydianiline (ODA), 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD) or p-phenylenediamine (PPD), or a mixture thereof. In a particular example, the diamine is oxydianiline (ODA). In another example, the diamine is m-phenylenediamine (MPD) or p-phenylenediamine (PPD).

The polyamic acid precursors, and, in particular, dianhydride and diamine, may react to form polyamic acid, which is imidized to form polyimide. In addition, an additive, such as a terminating agent, may form end-caps on the polyamic acid. An exemplary terminating agent may include an amine functional group or an anhydride functional group. In a particular embodiment, the terminating agent includes an anhydride functional group. For example, a terminating agent may be phenylethynylphthalic anhydride (PEPA) or norbornene anhydride (NA).

Such terminating agents may act to limit the molecular weight of the polyamic acid and resulting polyimide based on the amount of terminating agent added to the reactant mixture. In an exemplary embodiment, the polyimide is prepared to have a molecular weight of about 4,000 to about 12,000 gmu, such as about 5,000 to about 10,000 gmu, prior to sintering.

The ratio of reactants and terminating agents included in the reaction mixture influences the molecular weight and stoichiometric conversion of reactants. In an exemplary embodiment, dianhydride and diamine are added to the reaction mixture in a ratio of about 1:0.75 to about 1:1.08 dianhydride to diamine, such as about 1:0.95 to about 1:1.00 dianhydride to diamine. Further, the terminating agent may be added to the reaction mixture in a ratio of about 1:0.02 to about 1:0.06 dianhydride to terminating agent, such as a ratio of about 1:0.025 to about 1:0.050 dianhydride to terminating agent. In a particular embodiment, the polyimide includes polyetherimide, such as the imidized product of PMDA and ODA. As such, the dianhydride may include PMDA and the diamine may include ODA. In particular embodiments, a polyimide formed from PMDA, ODA, and terminating agents, such as anhydride based terminating agents, provides high thermal oxidative stability as indicated by high Degradation Onset Temperature, high glass transition temperature, or low thermal oxidative stability weight loss.

In addition to a terminating agent or alternatively, the composite material may include an additive, such as a metal oxide particulate dispersed in the polyimide matrix. The metal oxide particulate may include an oxide of a metal or a semi-metal selected from groups 1 through 16 of the periodic table. In particular, the metal oxide component may be an oxide of a metal or a semi-metal selected from groups 1 through 13, group 14 at or below period 3, group 15 at or below period 3, or group 16 at or below period 5. For example, the metal oxide may include an oxide of a metal or semi-metal selected from the group consisting of aluminum, antimony, barium, bismuth, boron, calcium, chromium, cobalt, copper, gallium, hafnium, iron, magnesium, manganese, molybdenum, nickel, niobium, phosphorous, silicon, tantalum, tellurium, tin, titanium, tungsten, vanadium, yttrium, zirconium, and zinc. In a particular embodiment, the metal oxide may include a metal oxide of aluminum, antimony, boron, calcium, gallium, hafnium, manganese, molybdenum, phosphorous, tantalum, tellurium, tin, tungsten, yttrium, or zinc. In a particular example, the metal oxide includes boronsilicate. In another embodiment, the metal oxide includes an oxide of gallium. In a further embodiment, the metal oxide includes an oxide of antimony. In an additional embodiment, the metal oxide includes an oxide of boron. Also, the metal oxide may include an oxide of tungsten. Further, the metal oxide may include an oxide of zinc. In addition, the metal oxide may include an oxide of phosphorous. In another example, the metal oxide includes an oxide of calcium. Herein, the term metal oxide is generally used to refer to oxides of metals and semi-metals.

In general, the metal oxide is in the form of particulate material. In an example, the particulate material has an average particle size not greater than about 100 microns, such as not greater than about 45 microns or not greater than about 5 microns. For example, the particulate material may have an average particle size not greater than about 1000 nm, such as not greater than about 500 nm or not greater than about 150 nm. Further, the average particle size may be at least about 10 nm, such as at least about 50 nm.

In a particular embodiment, the particulate material has a low aspect ratio. The aspect ratio is an average ratio of the longest dimension of a particle to the second longest dimension perpendicular to the longest dimension. For example, the particulate material may have an average aspect ratio not greater than about 2.0, such as about 1.0 or generally spherical.

In an exemplary embodiment, the composite material includes about 0.1 wt % to about 50.0 wt % metal oxide particulate. For example, the composite material may include about 0.1 wt % to about 20.0 wt % of the metal oxide particulate, such as about 0.1 wt % to about 10.0 wt % or about 0.1 wt % to about 5.0 wt % of the metal oxide particulate. In a particular example, the composite material may include less than about 5.0 wt %, such as about 0.1 wt % to about 2.5 wt % of the metal oxide particulate, such as about 0.5 wt % to about 2.5 wt % or about 0.5 wt % to about 1.5 wt % of the metal oxide particulate.

In another exemplary embodiment, the composite material may include large amounts of a second filler, such as a non-carbonaceous filler. In particular, the polyimide matrix may include at least about 55 wt % of a non-carbonaceous filler. Alternatively, the composite material may be free of other non-carbonaceous filler. Further, the composite material may include a coupling agent, a wetting agent, or a surfactant. In a particular embodiment, the composite material is free of coupling agents, wetting agents, and surfactants.

In addition, the composite material may include additives, such as carbonaceous materials. Carbonaceous materials are those materials, excluding polymers, that are formed predominantly of carbon (or organic materials processed to form predominantly carbon), such as graphite, amorphous carbon, diamond, carbon fibers, and fullerenes. In particular, the composite material may include graphite or amorphous carbon. In an exemplary embodiment, the composite material includes 0.0 wt % to about 45.0 wt % carbonaceous additive, such as about 10.0 wt % to about 40.0 wt % or about 15.0 wt % to about 25.0 wt %. Alternatively, particular embodiments are free of carbonaceous materials.

In an exemplary embodiment, the composite material exhibits improved temperature stability. The temperature stability may be characterized by a decrease in thermal oxidative stability weight loss during exposure to an air atmosphere at elevated temperatures or an increase in Degradation Onset Temperature based on thermal gravimetric analysis (TGA). The thermal oxidative stability weight loss is defined as the loss in weight when exposed to air at 371° C. (700° F.) and at atmospheric pressure for a period of 120 hours. In particular, the improvement in thermal stability may be characterized by a percent decrease in thermal oxidative weight loss of the composite relative to the base polyimide without an additive when exposed to thermal oxidative conditions (air at 371° C. (700° F.) and atmospheric pressure for a period of 120 hours), herein termed “thermal oxidative performance.” For example, the composite material may exhibit a thermal oxidative performance at least about 5.0%, such as at least about 10.0% or at least about 25.0%, relative to the polyimide without terminating agents and metal oxide. In particular embodiments, the composite material may exhibit a stability weight loss not greater than 3.0%. For example, the composite material may exhibit a thermal oxidative stability weight loss not greater than 2.7% or not greater than 2.5%.

The Degradation Onset Temperature is generally defined as the temperature at which the composite material loses 1.0 wt % when exposed to air at atmospheric pressure and ambient humidity for a period of 48 hours. The Degradation Onset Temperature is measured in a TGA Q500 by TA instruments. For example, the composite material may exhibit an Degradation Onset Temperature of at least about 520° C., such as at least about 530° C. or at least about 550° C. In particular, the Degradation Onset Temperature may be at least about 555° C. or at least about 560° C.

In an additional embodiment, the composite material may exhibit increased glass transition temperature (T_{g}) as determined by dynamic mechanical thermal analysis (DMA). DMA is performed using a DMA Q800 by TA Instruments under the conditions: amplitude 15 microns, frequency 1 Hz, air atmosphere, and a temperature program increasing from room temperature to 600° C. at a rate of 5° C./min. For example, the composite material may exhibit an increase in glass transition temperature (T_{g}) over that of the base polyimide without additive, herein “glass transition temperature performance,” of at least about 5.0%, such as at least about 10.0%, at least about 15.0%, or, in particular embodiments, at least about 20.0%. In a particular embodiment, the composite material exhibits a glass transition temperature of at least about 400° C., such as at least about 410° C., at least about 420° C., or at least about 430° C.

The composite material may also exhibit improved mechanical properties. For example, the composite material may exhibit improved tensile strength and elongation properties relative to the base polyimide used to form the composite material. In an exemplary embodiment, the composite material exhibits a Strength Performance of at least about 2.0%. The Strength Performance is defined as a percentage increase in tensile Strength Performance relative to the base polyimide without metal oxide particulate. For example, the composite material may exhibit a Strength Performance of at least about 4.5%, such as at least about 7.1 %, or at least about 10.0%. For a particular polyimide, such as the imidized product of PMDA and ODA, the tensile strength of the composite material may be at least about 72.3 MPa (10500 psi), such as at least about 82.0 MPa (11900 psi), at least about 84.1 MPa (12200 psi) or at least about 86.2 MPa (12500 psi). The tensile strength may, for example, be determined using a standard technique, such as ASTM D6456 using specimens conforming to D1708 and E8.

In addition, the composite material may exhibit an improved elongation, such as an Elongation Performance defined as a percentage increase in elongation-at-break of the composite material relative to the base polyimide. For example, the composite material may exhibit an Elongation Performance of at least about 5.0%, such as at least about 10.0% or at least about 20.0%. In particular embodiments, the composite material exhibits an elongation-at-break of at least about 10.5%, such as at least about 11.5%, at least about 12.5%, or at least about 15.0%.

In an exemplary method, the composite material is formed by preparing a mixture including unreacted polyamic acid precursors and a metal oxide particulate. In a particular example, the mixture includes the metal oxide particulate and at least one of a dianhydride and a diamine. The mixture may further include a solvent or a blend of solvents.

A solvent may be selected whose functional groups do not react with either of the reactants to any appreciable extent. In addition to being a solvent for the polyamic acid, the solvent is typically a solvent for at least one of the reactants (e.g., the diamine or the dianhydride). In a particular embodiment, the solvent is a solvent for both of the diamine and the dianhydride.

The solvent may be a polar solvent, a non-polar solvent or a mixture thereof. In an exemplary embodiment, the solvent is an aprotic dipolar organic solvent. An exemplary aprotic dipolar solvent includes N,N-dialkylcarboxylamide, N,N-dimethylformamide, N,N-dimethylacetamide, N,N-diethylformamaide, N,N-diethylacetamide, N,N-dimethylmethoxyacetamide, N-methyl caprolactam, dimethylsulfoxide, N-methyl-2-pyrrolidone, tetramethyl urea, pyridine, dimethylsulfone, hexamethylphosphoramide, tetramethylene sulfone, formamide, N-methylformamide, butylrolactone, or a mixture thereof. An exemplary non-polar solvent includes benzene, benzonitrile, dioxane, xylene, toluene, cyclohexane or a mixture thereof. Other exemplary solvents are of the halohydrocarbon class and include, for example, chlorobenzene.

In one exemplary embodiment, the solvent mixture includes a mixture of at least two solvents. The solvent ratio may result from mixing prior to adding reactant, may result from combining two reactant mixtures, or may result from addition of solvents or water entraining components during various parts of the process. In one exemplary embodiment, the resulting solvent mixture, such as the solvent mixture during polyamic acid imidization, includes an aprotic dipolar solvent and a non-polar solvent. The aprotic dipolar solvent and non-polar solvent may form a mixture having a ratio of 1:9 to 9:1 aprotic dipolar solvent to non-polar solvent, such as 1:3 to 6:1. For example, the ratio may be 1:1 to 6:1, such as 3.5:1 to 4:1 aprotic dipolar solvent to non-polar solvent.

Depending on the polyimide formation process, the solvent may be added prior to polyamic acid polymerization, during polyamic acid polymerization, after polyamic acid polymerization, during polyimide formation, after polyimide formation, or a combination thereof. For solution formed polyimide, reactants may be provided in solvent mixtures or added to solvent mixtures. Additional solvents may be added prior to dehydration or imidization, such as prior to azeotropic distillation. For precipitation formed polyimide, reactants may be provided in solvents or added to solvents. Polyimide may be precipitated from the solvent mixture through addition of dehydrating agents.

According to an embodiment, the metal oxide particulate may be added along with at least one polyamic acid precursor to a solvent prior to polymerization of the polyamic acid precursors. The addition may be performed under high shear conditions. In a particular embodiment, the metal oxide particulate may be milled, such as through ball milling, prior to addition to the mixture. In an exemplary embodiment, the mixture including the metal oxide particulate and the polyamic acid precursor in solvent has a Hegman grind gauge reading not greater than 5 microns, such as not greater than 1 micron.

In an exemplary method, a second polyamic acid precursor may be added to the mixture either in the form of a second mixture or as a dry component. In addition, a terminating agent may be added to the mixture, such as in the second mixture, in a third mixture, or as a dry component. In particular, a terminating agent having a functional group the same as the first polyamic acid precursor may be added to the mixture prior to addition of the second polyamic acid precursor. Alternatively, a terminating agent having the functional group of the second polyamic acid precursor may be added to the second mixture prior to mixing with the first mixture. For example, a terminating agent having an anhydride functional group may be added with the dianhydride reactant. A terminating agent having an amine functional group may be added with the diamine reactant.

The polyamic acid mixture is generally prepared by reacting a diamine component with a dianhydride component. In an exemplary embodiment, the dianhydride component and an anhydride terminating agent are added to a solvent mixture including the diamine component. In another exemplary embodiment, the dianhydride component and anhydride terminating agent are mixed with the diamine without solvent to form a dry mixture. Solvent is added to the dry mixture in measured quantities to control the reaction and form the polyamic acid mixture. In such an example, the metal oxide particulate may be mixed with the dry mixture prior to addition of the solvent. In a further exemplary embodiment, a mixture including diamine and a solvent is mixed with a second mixture including the dianhydride component and a solvent to form the polyamic acid mixture. The metal oxide particulate may be included in one or both of the mixtures and a terminating agent may be included in the mixture including the reactant having a similar functional group as the terminating agent. Alternatively, the metal oxide or a terminating agent may beaded to the mixture after formation of the polyamic acid or during formation of the polyimide.

In general, the polyamic acid reaction is exothermic. As such, the mixture may be cooled to control the reaction. In a particular embodiment, the temperature of the mixture may be maintained or controlled at about −10° C. to about 100° C., such as about 25° C. to about 70° C.

Once formed, the polyamic acid may be dehydrated or imidized to form polyimide. The polyimide may be formed in mixture from the polyamic acid mixture. For example, a Lewis base, such as a tertiary amine, may be added to the polyamic acid mixture and the polyamic acid mixture heated to form a polyimide mixture. Portions of the solvent may act to form azeotropes with water formed as a byproduct of the imidization. In an exemplary embodiment, the water byproduct may be removed by azeotropic distillation. See, for example, U.S. Pat. No. 4,413,117 or U.S. Pat. No. 3,422,061.

In another exemplary embodiment, polyimide may be precipitated from the polyamic acid mixture, for example, through addition of a dehydrating agent. Exemplary dehydrating agents include fatty acid anhydrides formed from acetic acid, propionic acid, butyric acid, or valeric acid, aromatic anhydride formed from benzoic acid or napthoic acid, anhydrides of carbonic acid or formic acid, aliphatic ketenes, or mixtures thereof. See, for example, U.S. Pat. No. 3,422,061.

In general, the polyimide product forms solids that are typically filtered, washed, and dried. For example, polyimide precipitate may be filtered and washed in a mixture including methanol, such as a mixture of methanol and water. The washed polyimide may be dried at a temperature between about 150° C. and about 300° C. for a period between 5 and 30 hours and, in general, at or below atmospheric pressure, such as partial vacuum (500-700 torr) or full vacuum (50-100 torr). As a result, a composite material is formed including a polyimide matrix having metal oxide particulate dispersed therein. The metal oxide particulate is generally evenly dispersed. Alternatively particular metal oxides, such as boron oxide, at least partially dissolve in the polyimide. In general, the metal oxides form a complex or react with the monomer. Without intending to be limited to a particular theory, such a complex or a reaction may act similar to crosslinking. In addition, such a complex may result in dissolution of particular species of metal oxide.

To form an article, the composite material may be hot pressed or press sintered. In another example, the composite material may be pressed and subsequently sintered to form the component. For example, the polyimide may be molded using high pressure sintering at temperatures of about 250° C. to about 450° C., such as about 350° C. and pressures at least about 351 kg/cm² (5 ksi), such as about 351 kg/cm² (5 ksi) to about 1406 kg/cm² (20 ksi) or, in other embodiments, as high as about 6250 kg/cm² (88.87 ksi).

### EXAMPLE 1

Samples of composite material including polyimide and including a metal oxide particulate are prepared and tested to determine mechanical properties and thermal stability. A mixture of oxydianiline (ODA), N-methylpyrrolidone (NMP), and xylene is prepared. Metal oxide is added to the mixture under high shear conditions. Pyromellitic dianhydride (PMDA) is added to the mixture under reaction conditions to a ratio of 1.000:1.0085 ODA to PMDA. The resulting mixture is azeotropically distilled and the thus formed polyimide is filtered, washed, and dried as described above.

The resulting polyimide is pressed and sintered into sheets and cut into standard shapes for testing. Table 1 illustrates the influence of metal oxide on mechanical properties, such as tensile strength and elongation, and Table 2 illustrates the influence of metal oxides on glass transition temperature and Degradation Onset Temperature. Tensile strength and elongation are determined in accordance with ASTM D6456 using sample conforming to D1708 or E8.

TABLE 1
Influence of Metal Oxide on Composite Tensile Strength and Elongation

| | | Tensile | Elongation |
|---|---|---|---|
| Sample | Metal Oxide | Strength (psi) | (%) |
| 1 | None | 10500 | 8.0 |
| 2 | 1.0 wt % Ta₂O₅ | 11,835 | 11.708 |
| 3 | 1.0 wt % Bi₂O₃ | 11,913 | 11.790 |
| 4 | 1.0 wt % NiO | 12,110 | 10.600 |
| 5 | 1.0 wt % MoO₃ | 12,131 | 11.262 |
| 6 | 1.0 wt % TeO₂ | 12,157 | 9.752 |
| 7 | 1.0 wt % WO_{2.9} | 12,175 | 12.891 |
| 8 | 1.0 wt % Bi₂O₃ | 12,227 | 10.441 |
| 9 | 1.0 wt % Boron Silicate | 12,264 | 12.901 |
| 10 | 1.0 wt % a-Al₂O₃ | 12,304 | 11.118 |
| 11 | 1.0 wt % Sb₂O₃ | 12,508 | 15.114 |
| 12 | 1.0 wt % WO₃ | 12,608 | 14.353 |
| 13 | 0.5 wt % B₂O₃ | 12,785 | 15.654 |
| 14 | 1.0 wt % Mn₂O₃ | 12,850 | 12.315 |
| 15 | 1.0 wt % B₂O₃ | 12,948 | 14.331 |
| 16 | 2.0 wt % B₂O₃ | 12,094 | 9.693 |
| 17 | 1.0 wt % Ga₂O₃ | 13,000 | 13.886 |

As illustrated Table 1, particular metal oxides in amounts from 0.5 wt % to 2.0 wt % increase tensile strength, an improvement over the base polymer sample, Sample 1 (Meldin® 7001). For example, samples including oxides of boron, tungsten, gallium, or antimony exhibit increased tensile strength relative to Sample 1. As illustrated, oxides of boron increases tensile strength in the base polyimide at 0.5 wt %, 1.0 wt % and 2.0 wt %. In particukar, such Samples exhibit increased tensile strength of at least about 2.0%, and, in some examples, at least about 10.0% over the base polyimide.

In addition, several samples including oxides increase elongation properties relative to the base polyimide sample, Sample 1. In particular, samples including oxides of boron, antimony or tungsten exhibit elongation greater than 14%, and even greater than 15.0%.

TABLE 2
Influence of Metal Oxide on Composite T_{g} and
Degradation Onset Temperature

| | | | Degradation |
|---|---|---|---|
| | | | Onset Temp. |
| Sample | Metal Oxide | T_{g} (° C.) | (° C.) |
| 1 | None | 365 | 545 |
| 4 | 1.0 wt % NiO | 400 | 554 |
| 6 | 1.0 wt % TeO₂ | 400 | 565 |
| 7 | 1.0 wt % WO_{2.9} | 421 | 566 |
| 8 | 1.0 wt % Bi₂O₃ | 400 | 562 |
| 9 | 1.0 wt % Boron Silicate | 423 | 555 |
| 10 | 1.0 wt % a-Al₂O₃ | 438 | 565 |
| 12 | 1.0 wt % WO₃ | 430 | 562 |
| 13 | 0.5 wt % B₂O₃ | 400 | 530 |
| 14 | 1.0 wt % Mn₂O₃ | 430 | 554 |
| 15 | 1.0 wt % B₂O₃ | 417 | 565 |
| 17 | 1.0 wt % Ga₂O₃ | 418 | 564 |

As illustrated in Table 2, samples including metal oxide exhibit high glass transition temperature (T_{g}) and high thermal oxidative stability. The glass transition temperatures are determined using dynamic mechanical thermal analysis (DMA). DMA is performed using a DMA Q800 by TA Instruments under the conditions: amplitude 15 microns, frequency 1 Hz, Air atmosphere, and a temperature program increasing from room temperature to 600° C. at a rate of 5° C./min. The Degradation Onset Temperature is determined using thermal gravimetric analysis (TGA) wherein the Degradation Onset Temperature is defined as the temperature at which the sample exhibits a 1.0% loss in weight when exposed to the temperature and air for 48 hours at atmospheric pressure. The Degradation Onset Temperature is measured in a TGA Q500 by TA instruments. The samples exhibit a glass transition temperature (T_{g}) of at least 400° C. Particular samples, including Samples 15 and 17, exhibit glass transition temperatures (T_{g}) greater than 410° C., and other samples, including Samples 7, 9, 10, 12, and 14, exhibit glass transition temperatures (T_{g}) greater than 420° C. As such, particular examples increase glass transition temperature (T_{g}) at least about 5% and, in some examples, at least about 20% over the base polyimide.

Further, the samples exhibit high Degradation Onset Temperatures. For example, Samples 4, 9 and 14 exhibit Degradation Onset Temperatures above 550° C. and Samples 6, 7, 8, 10, 12, 15, and 17 exhibit Degradation Onset Temperatures above 560° C.

### EXAMPLE 2

Exemplary samples are prepared as described below and tested for mechanical properties and thermal oxidative loss.

A mixture including 80 parts of oxydianiline (ODA), 1000 parts of N-methylpyrrolidone (NMP) and a specified amount of metal oxide are introduced into a reaction vessel. A second mixture including 122.4 parts PMDA and 183 parts NMP are added to the reaction vessel. When the reaction is complete, 6.42 parts of PMDA are added. In addition, 280 parts xylene are added to the mixture and the mixture is heated. Water is removed from the reaction mixture through azeotropic distillation. The polyimide precipitate including the metal oxide is filtered and washed with methanol. The filtered polyimide is dried for 15 hours at 100° C. to 130° C. at partial vacuum (500-700 torr) followed by 15-20 hours at 200° C. to 250° C. at full vacuum (10-50 torr).

As illustrated in Table 3, the samples are tested for elongation properties, tensile strength and thermal oxidative stability weight loss (TOS). For example, to determine thermal oxidative stability weight loss, the samples are exposed to air at a temperature of 371° C. (700° F.) and at atmospheric pressure for a period of 120 hours in a TGA apparatus.

TABLE 3
Effect of Metal Oxide on Mechanical Properties
and Thermal Oxidative Stability

| | | Tensile Strength | Elongation | TOS |
|---|---|---|---|---|
| Sample | Material | (psi) | (%) | (wt % loss) |
| 18 | No oxide | 7,662 | 4.629 | 4.21 |
| 19 | 1.0 wt % B₂O₃ | 9,955 | 5.771 | 2.4 |
| 20 | 1.0 wt % Sb₂O₃ | 8,278 | 4.476 | 2.37 |

As illustrated in Table 3, the samples including an oxide of boron or an oxide of antimony, Samples 19 and 20, respectively, exhibit increased tensile strength and elongation-at-break relative to the sample (Sample 18) including no oxide. In addition, the oxide containing samples exhibit decreased thermal oxidation rate, implying improved temperature stability and an increased maximum operating temperature.

### EXAMPLE 3

Samples of a composite material including polyimide having terminating agents and including a metal oxide particulate are prepared and tested to determine thermal stability. A mixture of oxydianiline (ODA), N-methylpyrrolidone (NMP), and xylene is prepared. Metal oxide particulate is added to the mixture under high shear conditions. In addition, 40 wt % particulate graphite is added to the mixture. Pyromellitic dianhydride (PMDA) and an anhydride terminating agent, such as phenylethynylphthalic anhydride (PEPA) or norbornene anhydride (NA), are added to the mixture under reaction conditions to a ratio of 1:0.975 PMDA to ODA and between 1:0.025 to 1:0.05 PMDA to terminating agent. The resulting mixture is azeotropically distilled and the thus formed polyimide is filtered, washed, and dried as described above.

As illustrated in Table 4, the composite materials of Samples 22 and 23 exhibit glass transition temperatures at least about 420° C. and Degradation Onset Temperatures greater than 530° C.

TABLE 4
Temperature Stability of Composite Materials

| | Terminating | Metal Oxide | | Degradation Onset |
|---|---|---|---|---|
| Sample | Agent | (1.0 wt %) | Tg (° C.) | Temp. (° C.) |
| 21 | NA | ZnO | 400 | 534 |
| 22 | NA | B₂O₃ | 421 | 557 |
| 23 | PEPA | B₂O₃ | 426 | 563 |

### EXAMPLE 4

A mixture including 80 parts of oxydianiline (ODA), 1000 parts of N-methylpyrrolidone (NMP) and a specified amount of metal oxide are introduced into a reaction vessel. A second mixture including 122.4 parts PMDA and 183 parts NMP are added to the reaction vessel. Optionally, 2.81 parts of norbornene anhydride are added to the reaction vessel. When the reaction is complete 6.42 parts of PMDA are added. In addition, 280 parts xylene are added to the mixture and the mixture is heated. Water is removed from the reaction mixture through azeotropic distillation. The polyimide precipitate including the metal oxide is filtered and washed with a 1:1 methanol/water mixture. The filtered polyimide is dried for 15 hours at 100° C. to 130° C. at partial vacuum (500-700 torr) followed by 15-20 hours at 200° C. to 250° C. at full vacuum (10-50 torr).

As illustrated in Table 5, the samples are tested for elongation properties, tensile strength and thermal oxidative stability weight loss (TOS). The sample (Sample 24) including an oxide of boron and an NA terminating agent, exhibit increased tensile strength and elongation-at-break relative to the sample (Sample 18) including no oxide and no terminating group. In addition, the oxide containing sample exhibits decreased thermal oxidation rate, implying improved temperature stability and an increased maximum operating temperature.

TABLE 5
Effect of Metal Oxide on Mechanical Properties
and Thermal Oxidative Stability

| | | Tensile | Elongation | TOS |
|---|---|---|---|---|
| Sample | Material | Strength (psi) | (%) | (wt % loss) |
| 18 | No oxide or | 7,662 | 4.629 | 4.21 |
| | terminating agent | | | |
| 24 | 1.0 wt % B₂O₃ and | 8,510 | 4,919 | 2.99 |
| | NA | | | |

### EXAMPLE 5

Samples of polyimide including particular metal oxides exhibit higher tensile strength and elongation properties than the base polyimide without metal oxide after exposure to high temperatures. Samples are prepared in accordance with Example 1. Table 6 illustrates tensile strength and elongation properties for samples after exposure to 427° C. (800° F.) in still air at atmospheric pressure for a period of 24 hours. As illustrated, samples including oxide exhibit higher tensile strength and higher elongation after exposure to thermal oxidative conditions.

TABLE 6
Post Thermal Oxidative Exposure Mechanical Properties

| | | Tensile Strength | Elongation |
|---|---|---|---|
| Sample | Material | (psi) | (%) |
| 25 | None | 5360 | 1.62 |
| 26 | 0.5 wt % B₂O₃ | 7105 | 2.10 |
| 27 | 1.0 wt % P₂O₅ | 7601 | 3.04 |
| 28 | 1.0 wt % Sb₂O₃ | 7402 | 2.14 |

### EXAMPLE 6

Samples including metal oxide and including graphite are exposed to thermal oxidative conditions. Samples are prepared in accordance with example 1 with the addition of 40 wt % graphite. Table 7 illustrates the thermal oxidative stability weight loss (TOS) of the samples. The sample including both metal oxide, such as B₂O₃, and graphite exhibits increased thermal oxidative stability relative to the sample including graphite and no metal oxide after exposure to 371° C. (700° F.) in air at atmospheric pressure for 120 hours, as indicated by a decrease in wt % loss.

TABLE 7
TOS of Samples including Graphite

| | | TOS |
|---|---|---|
| Sample | Material | (wt % loss) |
| 29 | 40 wt % Graphite | 3.6 |
| 30 | 40 wt % Graphite and | 1.79 |
| | 1.0 wt % B₂O₃ | |

Particular embodiments of the above-disclosed composite materials advantageously exhibit high thermal oxidative stability. While not intending to be limited to a particular theory, it is believed that cross-linking within the composite material may contribute to thermal oxidative characteristics. Such cross-linking may be produced as a result of organometallic crosslinking or complexing between the terminating agent, the metal oxides, and the polyimide, and, in particular, may be a result of including the terminating agent and metal oxide in the pre-reacted mixture with at least one of the polymer precursors prior to polymerization of the polymer precursors.

In another particular embodiment, the above-disclosed composite material advantageously exhibits improved mechanical properties, such as increased tensile strength and elongation. It is believed, without intending to be limited to a particular theory, that cross-linking may improve the mechanical properties of the composite material. Here again, cross-linking may result from dispersion or dissolution of a particular metal oxide, such as oxides of boron or antimony, in the polyimide matrix including terminating agents. Such metal oxides may form organometallic complexes and crosslinking sites, giving rise to higher glass transition temperatures (T_{g}).

While addition of B₂O₃ to polyimide has been noted in the literature, such as by Koton et al. (Koton et al., Thermal Stabilization of Polyimides by Triphenyl Phosphate, Translation from Zhurnal Prikladnoi Khimii, Vol. 56, No. 3, pp. 617-623, March 1983), prior art attempts show no improvement in stability under oxidative conditions. While the lack of stability of the prior art is somewhat unclear, the lack of thermal oxidative stability is believed to be caused by the particular processing employed by the prior art, including processing steps of adding B₂O₃ after formation of the polyimide. As noted above, particular embodiments herein notably utilize a process flow in which B₂O₃ is incorporated prior to polyamic acid formation.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A composite material comprising polyimide and an additive, the composite material having a glass transition temperature at least about 5% greater than the glass transition temperature of the polyimide absent the additive and having a thermal oxidative performance at least about 5% relative to the polyimide absent the additive, the thermal oxidative performance based on exposure to air at a temperature of 371° C. and at atmospheric pressure for a period of 120 hours.

2. The composite material of claim 1, wherein the thermal oxidative performance is at least about 10%.

3. (canceled)

4. The composite material of claim 1, wherein the glass transition temperature of the composite material is at least about 10% greater than the glass transition temperature of the polyimide absent the additive.

5. (canceled)

6. The composite material of claim 1, wherein composite material has a glass transition temperature of at least about 400° C.

7. The composite material of claim 6, wherein the glass transition temperature is at least about 410° C.

8.-9. (canceled)

10. The composite material of claim 1, wherein the composite material has an Degradation Onset Temperature of at least about 520° C.

11.-12. (canceled)

13. The composite material of claim 1, wherein the composite material has a thermal oxidative stability weight loss not greater than about 3.0% when exposed to air at a temperature of 371° C. and at atmospheric pressure for a period of 120 hours.

14.-15. (canceled)

16. The composite material of claim 1, wherein the additive is a terminating agent.

17. The composite material of claim 16, wherein the terminating agent forms terminal ends on the polyimide and wherein the polyimide is the imidized product of a dianhydride, and a diamine.

18. The composite material of claim 17, wherein the dianhydride comprises pyromellitic dianhydride (PMDA).

19. The composite material of claim 17, wherein the diamine comprises oxydianiline (ODA).

20. The composite-material of claim 16, wherein the terminating agent has an anhydride functional group.

21.-22. (canceled)

23. The composite material of claim 17, wherein the dianhydride and the diamine are included in a ratio of about 1:0.75 to about 1:1.08 dianhydride to diamine.

24. (canceled)

25. The composite material of claim 17, wherein the dianhydride and the terminating agent are included in a ratio of about 1:0.02 to about 1:0.06 dianhydride to terminating agent.

26. (canceled)

27. The composite material of claim 1, wherein the additive includes a metal oxide particulate.

28. The composite material of claim 27, wherein the composite material includes about 0.1 wt % to about 50.0 wt % of the metal oxide particulate.

29.-33. (canceled)

34. The composite material of claim 27, wherein the metal oxide particulate includes an oxide of a metal or a semi-metal selected from the group consisting of aluminum, antimony, barium, bismuth, boron, calcium, chromium, cobalt, copper, gallium, hafnium, iron, magnesium, manganese, molybdenum, nickel, niobium, phosphorous, silicon, tantalum, tellurium, tin, titanium, tungsten, vanadium, yttrium, zirconium, and zinc.

35. The composite material of claim 34, wherein the metal oxide particulate includes an oxide of gallium.

36. The composite material of claim 34, wherein the metal oxide particulate includes an oxide of antimony.

37. The composite material of claim 34, wherein the metal oxide particulate includes an oxide of boron.

38. (canceled)

39. The composite material of claim 34, wherein the metal oxide particulate includes an oxide of zinc.

40.-41. (canceled)

42. The composite material of claim 34, wherein the metal oxide particulate includes an oxide of calcium.

43.-48. (canceled)

49. A composite material comprising polyimide and an additive, the composite material having a glass transition temperature at least about 5.0% greater than the glass transition temperature of the polyimide absent the additive, the composite material having an Degradation Onset Temperature of at least about 550° C.

50. The composite material of claim 49, wherein the composite material has a glass transition temperature of at least about 400° C.

51.-81. (canceled)

82. A composite material comprising a polyimide and an additive, the composite material having a tensile strength at least about 72.3 MPa (10500 psi) and having a thermal oxidative performance at least about 5.0% relative to the polyimide absent the additive, the thermal oxidative performance based on exposure to air at a temperature of 371° C. and at atmospheric pressure for a period of 120 hours.

83. The composite material of claim 82, wherein the thermal oxidative performance is at least about 10.0%.

84.-95. (canceled)
